(19) United States
(12) Patent Application Publication
(10) Pub. No.: US 2024/0207872 A1
(43) Pub. Date: Jun. 27, 2024

(54) FILTER FOR HOLLOW-CONE NOZZLE BODY

(71) Applicant: Aero Pump GmbH, Hochheim/Main (DE)

(72) Inventors: Milena Angelika MARSZALEK, Mainz (DE); Sebastian ROTHER, Mainz (DE)

(73) Assignee: Aero Pump GmbH, Hochheim/Main (DE)

(21) Appl. No.: 18/391,782

(22) Filed: Dec. 21, 2023

(30) Foreign Application Priority Data
Dec. 23, 2022 (DE) 10 2022 134 681.1

(51) Int. Cl. B05B 1/34; B05B 15/40

(52) U.S. Cl. CPC B05B 1/3442; B05B 15/40

(57) ABSTRACT

A hollow-cone nozzle body includes at least one nozzle geometry; at least one turbulence chamber; and at least one turbulence channel. The turbulence channel tangentially opens into the turbulence chamber, and the at least one turbulence channel comprises at least one filter arrangement.

### CROSS-REFERENCE TO RELATED APPLICATION

This application claims priority under 35 U.S.C. § 119(a) to German Application No. 10 2022 134 681.1 filed Dec. 23, 2022, the disclosure of which is expressly incorporated by reference herein in its entirety.

### BACKGROUND

### 1. Field of the Invention

The present invention relates to a hollow-cone nozzle body having at least one nozzle geometry, at least one turbulence chamber, and at least one turbulence channel, wherein the turbulence channel tangentially opens into the turbulence chamber.

### 2. Discussion of Background Information

In hollow-cone nozzle bodies, fluid is fed into the turbulence chamber via a turbulence channel, wherein the turbulence channel tangentially opens into the turbulence chamber. As a result, the fluid is set in rotation inside the turbulence chamber until said fluid is ultimately ejected through the nozzle geometry. During the ejection procedure, the fluid is pressed through the nozzle geometry starting from the turbulence chamber, wherein the fluid is atomized upon exiting the nozzle geometry. This results in an aerosol.

The turbulence chamber and the nozzle geometry can be arranged in rotational symmetry about a common axis. This is what is referred to as a symmetrical hollow-cone nozzle geometry. Alternatively, the turbulence chamber can be embodied to be asymmetrical, wherein a nozzle geometry is arranged at the end of the turbulence chamber. In the case of an asymmetrical nozzle geometry, this is referred to as an asymmetrical hollow-cone nozzle.

The hollow-cone nozzle bodies are produced using an injection molding method, for example. Alternatively, hollow-cone nozzle blanks produced using an injection molding method can also be processed into a hollow-cone nozzle body using a laser processing. Due to the advancement in the accuracy and processing precision, ever smaller dimensions of the individual geometries such as the nozzle geometry, the turbulence chamber, and/or the turbulence channel, for example, are possible. The result of the dimensions becoming ever smaller is that small particles can cause the nozzle geometry, the turbulence chamber, and/or the turbulence channel to become clogged. This leads to the hollow-cone nozzle body ceasing to properly function.

### SUMMARY

According to embodiments, a hollow-cone nozzle body is provided, which ensures a proper use.

In embodiments, the at least one turbulence channel includes at least one filter arrangement. Using this filter arrangement, particles that are located in the fluid can be filtered out. The result is that downstream fluid-carrying geometries, such as the turbulence chamber, the turbulence channel, and/or the nozzle geometry, can no longer be clogged by the particles, which have been filtered out. A proper use of the hollow-cone nozzle body can thus be ensured.

Preferably, the at least one filter arrangement is integrated into the hollow-cone nozzle body. Accordingly, the filter arrangement and the hollow-cone nozzle body are embodied in one piece. The filter arrangement can thus already be created as part of the production process for the hollow-cone nozzle body, for example. An assembly cost is thus minimized through the use of a filter arrangement according to the invention. This results in good cost efficiency. Furthermore, production methods and processes already in existence do not need to be modified, but rather can also be used for the disposal according to the invention of a filter arrangement in the hollow-cone nozzle body. The assembly costs are thus minimized.

The filter arrangement preferably includes at least one filter channel. The filter channel is thereby essentially oriented along the turbulence channel. Furthermore, a filter channel has a longitudinal extension so that at high pressures, for example, particles cannot simply be pushed through the filter channel, for example. Instead, such particles remain stuck in the filter channel, so that a good use of the hollow-cone nozzle body can be ensured as a result. The filter arrangement can comprise one, two, three, or more filter channels, for example. If more than one filter channel is provided, fluid can be transferred through the remaining filter channels if a filter channel is clogged. A use of the hollow-cone nozzle body is thus ensured.

Preferably, the at least one filter channel has a first cross-sectional area which is smaller than a second cross-sectional area of the nozzle geometry. The first cross-sectional area thereby refers to the cross-sectional area of a single filter channel. This prevents particles from passing the filter arrangement to then clog the nozzle geometry. Instead, particles are filtered out by the filter arrangement, so that said particles are no longer able to clog the nozzle geometry. A use of the hollow-cone nozzle body is thus ensured.

Preferably, the filter arrangement comprises a third cross-sectional area which is arranged perpendicularly to the direction of flow, wherein a width of the third cross-sectional area is a multiple of a height of the third cross-sectional area, wherein the width is arranged perpendicularly to the height. The direction of flow thereby corresponds to the flow direction of the fluid that is to be ejected through the nozzle geometry. In the present case, the filter arrangement is arranged in the turbulence channel so that the direction of flow corresponds to the direction of flow of the turbulence channel. The width of the third cross-sectional area thereby corresponds to the total width of all filter channels, while the height corresponds to the height of the filter channels. A planar disposal of the filter arrangement is thereby achieved. This arrangement can be easily produced.

The filter arrangement preferably terminates with an upper boundary of the at least one turbulence channel. The filter arrangement is thus integrated into the at least one turbulence channel. A good leak-tightness is thus achieved. Other components of a hollow-cone nozzle spray can also be used without needing to be adapted. A good cost efficiency is achieved as a result.

Preferably, the at least one turbulence channel is wider in a region of the filter arrangement than in remaining regions of the at least one turbulence channel. As a result, the filter arrangement can be sized appropriately so that a good fluid permeability continues to be ensured. In addition, a fluid resistance that is caused by the filter arrangement is minimized. An unimpaired use of the hollow-cone nozzle body is thus also achieved.

Preferably, the filter arrangement can be produced using an injection molding method and/or a laser processing. As a result, the filter arrangement can be realized within the scope of the already-known production options for hollow-cone nozzle bodies. This constitutes a cost-effective measure.

Embodiments are directed to a hollow-cone nozzle body that includes at least one nozzle geometry; at least one turbulence chamber; and at least one turbulence channel. The turbulence channel tangentially opens into the turbulence chamber, and the at least one turbulence channel comprises at least one filter arrangement.

In embodiments, the at least one filter arrangement may be integrated into the hollow-cone nozzle body.

According to embodiments, the at least one filter arrangement can include at least one filter channel.

In accordance with embodiments, the at least one filter channel can have a first cross-sectional area which is smaller than a second cross-sectional area of the nozzle geometry.

According to other embodiments, the at least one filter arrangement may include a third cross-sectional area which is arranged perpendicularly to a direction of flow, and a width of the third cross-sectional area is a multiple of a height of the third cross-sectional area, where the width is arranged perpendicularly to the height.

In other embodiments, the at least one filter arrangement may terminate with an upper boundary of the at least one turbulence channel.

In accordance with other embodiments, the at least one turbulence channel may be wider in a region of the filter arrangement than in remaining regions of the at least one turbulence channel.

According to still other embodiments, the at least one filter arrangement can be produced using an injection molding method and/or a laser processing.

In still other embodiments, the at least one nozzle geometry, the at least one turbulence chamber, and the at least one turbulence channel can be arranged so that fluid is directed through the at least one filter arrangement into the least one turbulence channel to be tangentially guided into the turbulence chamber, whereby the fluid is set in rotation.

In accordance with still yet other embodiments, the at least one filter channel may include a plurality of filter channels and the at least one nozzle geometry, the at least one turbulence chamber, and the at least one turbulence channel can be arranged so that fluid is directed through the plurality of filter channels into the least one turbulence channel to be tangentially guided into the turbulence chamber, whereby the fluid is set in rotation. Further, the at least one turbulence channel can be arranged so that the fluid directed through the plurality of filter channels converge into the at least one turbulence channel. Each of the plurality of filter channels can have a width that is smaller than a width of the nozzle geometry.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic plan view of a hollow-cone nozzle body with a view of the turbulence chamber;

FIG. 2 shows a sectional illustration of a hollow-cone nozzle body along the line A-A depicted in FIG. 1;

FIG. 3 shows a detailed view of the filter arrangement shown in FIG. 1; and

FIG. 4 shows a sectional illustration of the filter arrangement illustrated in FIG. 3.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

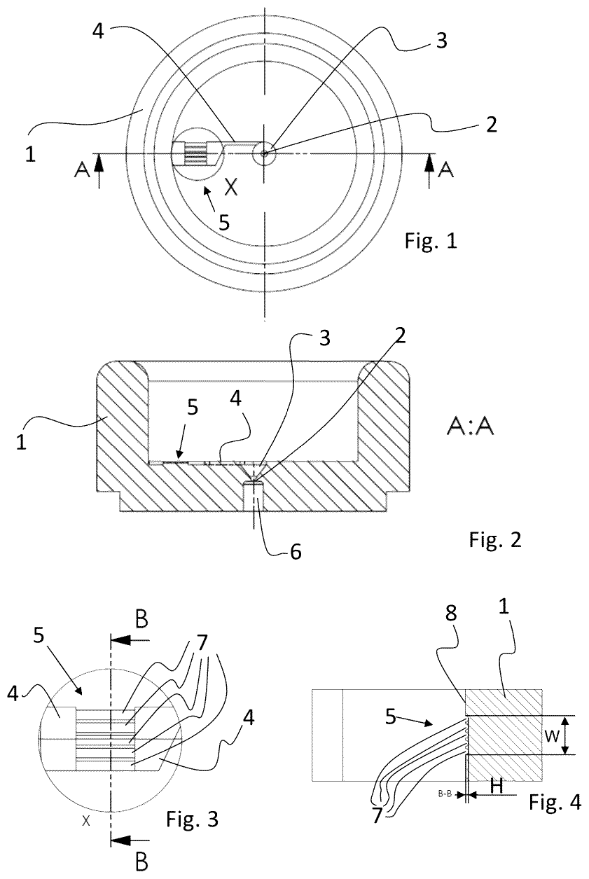

FIG. 1 shows a hollow-cone nozzle body 1 which comprises a nozzle geometry 2, a turbulence chamber 3, a turbulence channel 4, and a filter arrangement 5. Fluid is thereby transferred through the filter arrangement starting from the left-hand side of the filter arrangement in order to then be tangentially guided into the turbulence chamber 3 via the turbulence channel 4. There, the fluid is set in rotation and subsequently ejected through the nozzle geometry 2.

FIG. 2 shows a sectional illustration of the hollow-cone nozzle body 1 illustrated in FIG. 1, along the section line A-A. In FIG. 2, the hollow-cone nozzle body 1 is illustrated with the filter arrangement 5, the turbulence chamber 3, and the nozzle geometry 2. The turbulence chamber 3 is embodied to be funnel-shaped. Fluid is thereby tangentially fed through the turbulence channel 4 at the wide end of the funnel. Inside the turbulence chamber 3, the fluid is set in rotation in order to then be ejected through the nozzle geometry 2. The fluid is thereby transferred to an outside of the hollow-cone nozzle body in an ejection recess 6. The filter arrangement 5 terminates at the same height as an upper boundary of the turbulence channel 4. The turbulence channel 4 is illustrated by a dashed line in this case.

FIG. 3 shows the detail X depicted in FIG. 1, which shows the filter arrangement 5 in detail. The filter arrangement 5 is embodied in one piece with the hollow-cone nozzle body 1 and, in the present exemplary embodiment, comprises four filter channels 7. Fluid is thereby transferred to the right-hand side of the filter arrangement through the filter channels 7 starting from a left-hand side of the filter arrangement 5. From the right-hand side of the filter arrangement 5, the fluid is then transferred into the turbulence channel 4. The filter arrangement serves as a screen or filter to filter the fluid, in order to ultimately prevent a clogging of the nozzle geometry 2.

FIG. 4 shows a sectional illustration along the line B-B depicted from FIG. 3. In the present exemplary embodiment, the individual filter channels 7 have a semicircular cross section that extends into the material of the hollow-cone nozzle body starting from a surface 8. The surface 8 also forms the upper boundary of the at least one turbulence channel 4. Furthermore, a third cross-sectional area of the filter arrangement 5 is visible in FIG. 4. The third cross-sectional area thereby corresponds to a width W of all illustrated fluid channels 7, and a height H corresponds to the extension of the fluid channels 7 into the material of the hollow-cone nozzle body 1 starting from the surface 8. The fluid channels 7 are arranged adjacently to one another and form a matrix with a column or a row.

The at least one filter channel 7 comprises a first cross-sectional area which is smaller than a second cross-sectional area of the nozzle geometry. The first cross-sectional area thereby corresponds to the area through which fluid is conveyed. The second cross-sectional area likewise corresponds to an area through which fluid can be transferred. The second cross-sectional area is thereby the smallest cross-sectional area of the nozzle geometry. Because the first cross-sectional area is smaller than the second cross-sectional area, particles that could clog the second cross-sectional area or the nozzle geometry 2 are already filtered out ahead of time by the filter arrangement 5.

Since the individual fluid channels 7 are arranged column-wise or row-wise adjacently to one another, the filter arrangement 5 can already be integrated into the production process for the hollow-cone nozzle body 1. The hollow-cone nozzle body 1 can be comprehensively produced using an injection molding method, for example. Alternatively, the hollow-cone nozzle body 1 can initially be embodied as a hollow-cone nozzle blank which is then processed into a hollow-cone nozzle body 1 using a laser processing. The turbulence channel 4 of the present exemplary embodiment has a smaller width than the filter arrangement 5. As a result, multiple filter channels 7 can be arranged adjacently to one another in order to ensure a required flow rate of the fluid.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE SYMBOLS

1 Hollow-cone nozzle body
2 Nozzle geometry
3 Turbulence chamber
4 Turbulence channel
5 Filter arrangement
6 Ejection recess
7 Filter channel
8 Surface
W Width of a third cross section
H Height of a third cross section

1. A hollow-cone nozzle body comprising:
at least one nozzle geometry;
at least one turbulence chamber; and
at least one turbulence channel,
wherein the turbulence channel tangentially opens into the turbulence chamber, and
wherein the at least one turbulence channel comprises at least one filter arrangement.

2. The hollow-cone nozzle body according to claim 1, wherein the at least one filter arrangement is integrated into the hollow-cone nozzle body.

3. The hollow-cone nozzle body according to claim 1, wherein the at least one filter arrangement comprises at least one filter channel.

4. The hollow-cone nozzle body according to claim 3, wherein the at least one filter channel has a first cross-sectional area which is smaller than a second cross-sectional area of the nozzle geometry.

5. The hollow-cone nozzle body according to claim 1, wherein the at least one filter arrangement comprises a third cross-sectional area which is arranged perpendicularly to a direction of flow, and
wherein a width of the third cross-sectional area is a multiple of a height of the third cross-sectional area, where the width is arranged perpendicularly to the height.

6. The hollow-cone nozzle body according to claim 1, wherein the at least one filter arrangement terminates with an upper boundary of the at least one turbulence channel.

7. The hollow-cone nozzle body according to claim 1, wherein the at least one turbulence channel is wider in a region of the filter arrangement than in remaining regions of the at least one turbulence channel.

8. The hollow-cone nozzle body according to claim 1, wherein the at least one filter arrangement is produced using an injection molding method and/or a laser processing.

9. The hollow-cone nozzle body according to claim 1, wherein the at least one nozzle geometry, the at least one turbulence chamber, and the at least one turbulence channel are arranged so that fluid is directed through the at least one filter arrangement into the least one turbulence channel to be tangentially guided into the turbulence chamber, whereby the fluid is set in rotation.

10. The hollow-cone nozzle body according to claim 3, wherein the at least one filter channel comprises a plurality of filter channels and the at least one nozzle geometry, the at least one turbulence chamber, and the at least one turbulence channel are arranged so that fluid is directed through the plurality of filter channels into the least one turbulence channel to be tangentially guided into the turbulence chamber, whereby the fluid is set in rotation.

11. The hollow-cone nozzle body according to claim 10, wherein the at least one turbulence channel is arranged so that the fluid directed through the plurality of filter channels converge into the at least one turbulence channel.

12. The hollow-cone nozzle body according to claim 11, wherein each of the plurality of filter channels has a first cross-sectional area that is smaller than a second cross-sectional area of the nozzle geometry.

13. The hollow-cone nozzle body according to claim 3, wherein the at least one filter channel comprises a plurality of filter channels and cach of the plurality of filter channels has a smallest first cross-sectional area which is smaller than a smallest second cross-sectional area of the nozzle geometry.

14. The hollow-cone nozzle body according to claim 11, wherein each of the plurality of filter channels has a smallest first cross-sectional area that is smaller than a smallest second cross-sectional area of the nozzle geometry.
